(19) United States
(12) Patent Application Publication
(10) Pub. No.: US 2005/0100140 A1
(43) Pub. Date: May 12, 2005

(54) Automatic phone-answering method by ring duration

(76) Inventor: Wei-Sheng Tsai, Kao Hsiung City (TW)

Correspondence Address: BIRCH STEWART KOLASCH & BIRCH, PO BOX 747, FALLS CHURCH, VA, 22040-0747, US

(21) Appl. No.: 10/702,553

(22) Filed: Nov. 7, 2003

(51) Int. Cl. H04M 1/64; H04M 3/42

(52) U.S. Cl. 379/82; 379/207.09

(57) ABSTRACT

A method automatically answers a phone call by counting ring duration. When an incoming call is detected, an elapsed time counter is disabled if it is previously activated. The phone call is automatically detected if a timer counts out a predetermined ring duration and a counter counts out a predetermined calling number. After answering the phone call, the counter is reset to an initial state.

### FIELD OF THE INVENTION

The present invention relates to an automatic phone-answering method by ring duration and, more particularly, to a method capable of determining whether a timer counts out different predetermined ring durations in proper order when a user dials to an communication device many times, hence accomplishing automatic phone-answering of the communication device.

### BACKGROUND OF THE INVENTION

An existent telephone having the automatic phone-answering function comprises a telephone interface, a ring and hook detector, a loudspeaker, a voice generator and a control circuit. The control circuit is connected to the ring and hook detector, the loudspeaker and the voice generator. The control circuit controls the telephone interface to let the telephone directly connect the telephone line and let the loudspeaker and the voice generator not work when the ring and hook detector detects the mouthpiece of the telephone has been taken up. The control circuit also controls the voice generator to automatically answer a phone call, ask for the identity of the caller and reject the call according to predetermined voice signals when the ring and hook detector detects there is a ring signal on the telephone line. The control circuit can also simultaneously let the loudspeaker be connected with the telephone line to amplify and output sound signals from the telephone line so as to let a user be capable of hearing the voice of the caller without answering the phone call.

In other words, the voice generator is used to automatically answer a phone call, ask the identity of the caller or reject a phone call at suitable times according to predetermined voice signals.

There is also a phone-answering protocol device using the number of times of the ring signal as a secret sign. This phone-answering protocol device comprises a microcomputer control unit as the center. The microcomputer control unit is connected to a detection circuit, a vibration circuit, an output control circuit, a ring device, a dial circuit, a voice circuit and a keyboard.

The input line of the microcomputer control unit is connected with the detection circuit, and the output line thereof is connected with the output control circuit. A software program is also provided to accomplish the object of the protocol by the number of input times of the ring signal and the maximum elapsed time of the dial action.

Because there are many different types of the number of input times of the ring signal, the application of the above phone-answering protocol device is much limited.

### SUMMARY OF THE INVENTION

One object of the present invention is to provide a method capable of determining whether a timer counts out different predetermined ring duration in proper order when a user dials to a telephone or mobile phone many times, hence accomplishing automatic phone-answering of the telephone or mobile phone.

To achieve the above object, the automatic phone-answering method by ring duration of the present invention comprises the steps of:
determining whether an elapsed time counter is activated when there is an incoming call;
stopping the action of the elapsed time counter if the elapsed time counter is activated;
determining whether a timer counts out a predetermined ring duration;
determining whether a counter counts out a predetermined calling number if the timer counts out the predetermined ring duration;
automatically answering the incoming call if the counter counts out a predetermined calling number; and
resetting the counter to an initial state.

If the above elapsed time counter hasn't been activated, the counter is reset, and the timer is activated.

If the above timer doesn't count out the predetermined ring duration, the counter is reset, and the timer is activated.

After the above timer is activated, if the incoming call is answered by someone, the timer is stopped, and the counter is reset to the initial state. If there is no one answering the incoming call, the incoming call is ringed off, and the timer is stopped. After the timer is stopped, the value of the timer is checked to see whether the value of the timer is the predetermined value. If the answer is no, the counter is reset to the initial state. Otherwise, the value of the counter is added by 1, the elapsed time counter is activated, and the counter is then reset to the initial state.

The various objects and advantages of the present invention will be more readily understood from the following detailed description when read in conjunction with the appended drawing, in which:

### BRIEF DESCRIPTION OF THE DRAWINGS

FIGS. 1A and B show the flowchart of the present invention.

### DETAILED DESCRIPTION OF THE PREFERRED EMBODIMENTS

The present invention provides an automatic phone-answering method by ring duration. The components of the present invention comprise a ring detector, a timer, a counter and a control circuit (not shown).

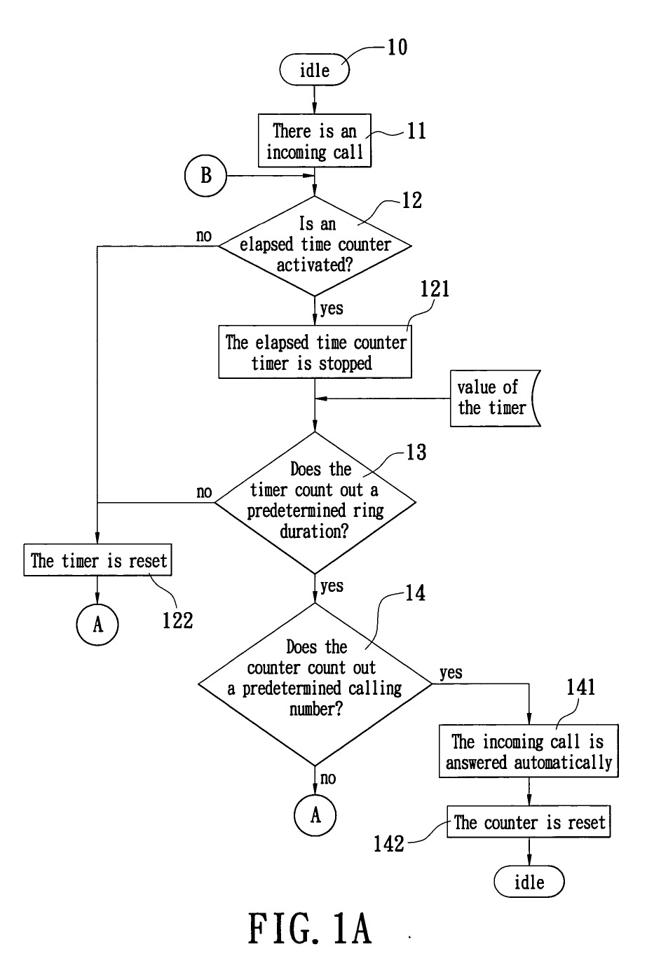

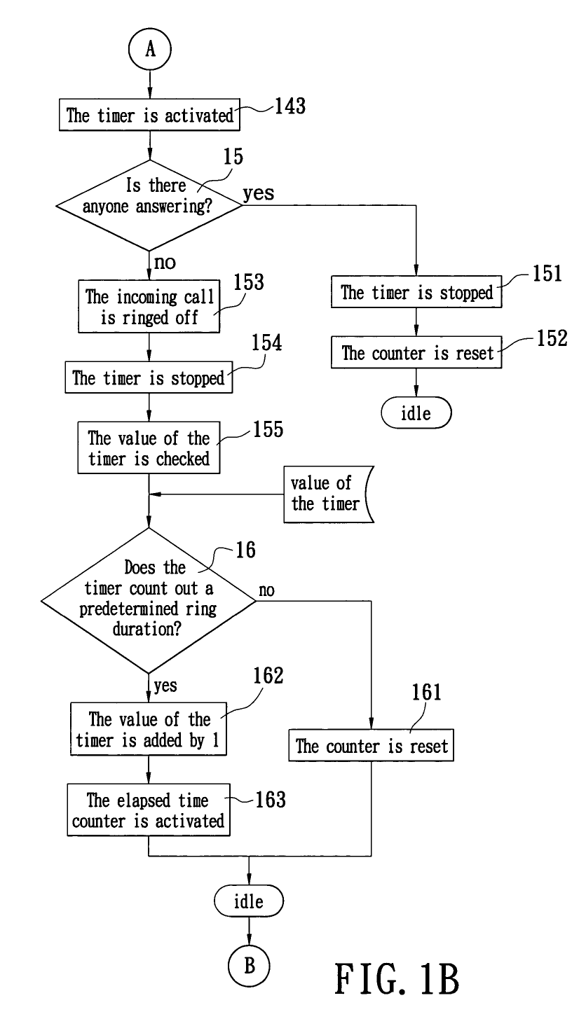

FIGS. 1A and 1B show the flowchart of an automatic phone-answering method by ring duration of the present invention. The flowchart comprises the following steps.
Step 11: There is an incoming call; Step 12 is then jumped to;
Step 12: Whether an elapsed time counter has been activated is determined. If the elapsed time counter has been activated, Step 121 is jumped to; otherwise, Step 122 is jumped to;
Step 121: The elapsed time counter timer is stopped. Step 13 is then jumped to;
Step 122: The counter (for counting the number of times of dial) is reset. Step 143 is then jumped to;
Step 13: Whether the value of the timer is the predetermined vault is determined. If the answer is yes, Step 14 is jumped to; otherwise, Step 122 is jumped back to;
Step 14: Whether the counter counts out a predetermined calling number is determined. If the answer is yes, Step 141 is jumped to; otherwise, Step 143 is jumped to;
Step 141: The incoming call is answered automatically. Step 142 is then jumped to for resetting the counter to an initial state;
Step 143: The timer is activated. Step 15 is then jumped to;
Step 15: Whether there is anyone answering the incoming call is determined. If the answer is yes, Step 151 is jumped to; otherwise, Step 153 is jumped to;
Step 151: The timer is stopped. Step 152 is then jumped to for resetting the counter to the initial state;
Step 153: The incoming call is ringed off. Step 154 is then jumped to for stopping the timer;
Step 155: The value of the timer is checked. Step 16 is then jumped to;
Step 16: Whether the value of the timer is the predetermined value is determined. If the answer is yes, Step 161 is jumped to; otherwise, Step 162 is jumped to;
Step 161: The counter is reset to the initial state; and
162: The value of the timer is added by 1. Step 163 is then jumped to for activating the elapsed time counter and resetting the counter to the initial state.

To sum up, the present invention provides a method, which can determine whether a timer counts out different predetermined ring duration in proper order when a user dials to a telephone or a mobile phone many times, hence accomplishing automatic phone-answering of the telephone or mobile phone.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. An automatic phone-answering method by ring duration of a communication device comprising the steps of:
determining whether an elapsed time counter is activated when there is an incoming call;
stopping the action of said elapsed time counter if said elapsed time counter is activated;
determining whether a timer counts out a predetermined ring duration;
determining whether a counter counts out predetermined calling number if said timer counts out the predetermined ring duration;
automatically answering the incoming call if said counter counts out the predetermined calling number; and
resetting said counter to an initial state.

2. The automatic phone-answering method by ring duration as claimed in claim 1, wherein said counter is reset and said timer is activated if said elapsed time counter hasn't been activated.

3. The automatic phone-answering method by ring duration as claimed in claim 1, wherein said counter is reset and said timer is activated if said timer doesn't count out the predetermined ring duration.

4. The automatic phone-answering method by ring duration as claimed in claim 2, wherein said timer is stopped and said counter is reset to the initial state if the incoming call is answered by someone after said timer is activated.

5. The automatic phone-answering method by ring duration as claimed in claim 2, wherein the incoming call is ringed off and said timer is stopped if there is no one answering the incoming call after said timer is activated.

6. The automatic phone-answering method by ring duration as claimed in claim 5, wherein after said timer is stopped, the value of said time is immediately checked, and whether the value of said timer is the predetermined value is determined, and said counter is reset to the initial state if the answer is no, or the value of said counter is added by 1 and said elapsed time counter is activated and then said counter is reset to the initial state if the answer is yes.

7. The automatic phone-answering method by ring duration as claimed in claim 1, wherein said communication device can be a telephone or a mobile phone.
